(19) United States
(12) Patent Application Publication
(10) Pub. No.: US 2026/0063853 A1
(43) Pub. Date: Mar. 5, 2026

(54) CO-OPTICAL PACKAGE AND MANUFACTURING METHOD THEREOF

(71) Applicant: SILICONWARE PRECISION INDUSTRIES CO., LTD., Taichung City (TW)

(72) Inventors: Che-Yu LEE, Taichung City (TW); Wen-Jung TSAI, Taichung City (TW); Shuai-Lin LIU, Taichung City (TW); En-Hao CHANG, Taichung City (TW); Feng KAO, Taichung City (TW)

(73) Assignee: SILICONWARE PRECISION INDUSTRIES CO., LTD., Taichung City (TW)

(21) Appl. No.: 19/003,750

(22) Filed: Dec. 27, 2024

(30) Foreign Application Priority Data
Aug. 29, 2024 (TW) 113132650

(51) Int. Cl. G02B 6/42

(52) U.S. Cl. CPC G02B 6/4206

(57) ABSTRACT

A co-optical package and a manufacturing method thereof are provided. An electronic module includes a circuit structure, an electronic element and a photonic element. The circuit structure has a first side and a second side opposite to the first side. The electronic element is embedded in the circuit structure or disposed on the first side of the circuit structure. The photonic element having an optical active surface is embedded in the circuit structure and electrically connected to the electronic element. A portion of the circuit structure is removed from the first side to form an opening to expose the optical active surface of the photonic element. An optical element is disposed at the opening of the circuit structure and combined with the optical active surface of the photonic element. An encapsulation layer is formed on the first side of the circuit structure and covers the optical element.

### BACKGROUND

### 1. Technical Field

The present disclosure relates to a manufacturing technology of a co-optical package, and more particularly, to a co-optical package that integrates with an electronic element, a photonic element and an optical element and a manufacturing method thereof.

### 2. Description of Related Art

Co-packaged optics (CPO) is an optoelectronic integration scheme based on silicon photonic technology, which can integrate photonic elements and electronic elements into a single package to achieve data transmission and processing with high performance and low power consumption.

Silicon photonic technology uses silicon as a base material to manufacture optoelectronic elements (such as optical waveguides, optical modulators, detectors, etc.), and silicon photonic technology has the following advantages: 1. High integration: silicon photonic technology can integrate photonic elements and electronic elements into a single package to reduce the optical fiber connections and photoelectric conversion processes required in traditional optoelectronic elements. 2. Low cost: silicon is the main material in the semiconductor industry, and silicon photonic technology can utilize existing semiconductor manufacturing processes and equipment to reduce production cost. 3. High speed and low latency: silicon photonic technology can support high-speed data transmission, and the latency of photonic transmission is lower than that of traditional electronic transmission.

In the silicon photonic technology, how to effectively introduce and transmit optical signals is crucial. The followings are several common methods: 1. Optical coupling: microlenses, grating couplers and other technologies are used to couple external optical signals into photonic elements, and optical couplers can achieve efficient entry and exit of optical signals to ensure the integrity of the optical signals. 2. Optical fiber docking: directly docking optical fibers to photonic elements requires precise alignment and stable connection technique to ensure low loss and high reliability of optical signal transmission. 3. Internal light source: integrate the light source inside the photonic chip to reduce the need for external optical coupling and improve the integration and reliability of the system.

However, although silicon photonic technology can integrate photonic elements and electronic elements into a single package, how to effectively introduce optical signals to avoid or reduce the loss of the optical signals is a key point for the successful application of silicon photonic technology, and there is still room for improvement in this technology.

In addition, the conventional technology cannot effectively integrate electronic elements, photonic elements and optical elements via a single module or a circuit structure, nor can it embed photonic elements in the circuit structure to combine special designed optical elements, nor can it form a tapered opening on the circuit structure to quickly align optical elements and photonic elements, and it is further impossible to form a slope on the optical element to concurrently align the photonic elements and optical fibers.

Therefore, there is a need for a solution that addresses the aforementioned shortcomings in the prior art.

### SUMMARY

In view of the aforementioned shortcomings of the prior art, the present disclosure provides a co-optical package, which comprises: a circuit structure having a first side, a second side opposite to the first side, and an opening, wherein the opening is formed on the first side of the circuit structure; at least one electronic element embedded in the circuit structure or disposed on the first side of the circuit structure; a photonic element embedded in the circuit structure and electrically connected to the at least one electronic element, wherein the photonic element has an optical active surface exposed from the opening of the circuit structure; an optical element disposed at the opening of the circuit structure, wherein the optical element is combined with or corresponds to the optical active surface of the photonic element; and an encapsulation layer formed on the first side of the circuit structure and the optical element and covering the optical element.

The present disclosure further provides a method of manufacturing a co-optical package, the method comprises: providing an electronic module including a circuit structure, at least one electronic element and a photonic element, wherein the circuit structure has a first side and a second side opposite to the first side, the at least one electronic element is embedded in the circuit structure or disposed on the first side of the circuit structure, wherein the photonic element has an optical active surface, is embedded in the circuit structure and is electrically connected to the at least one electronic element; removing a portion of the circuit structure from the first side of the circuit structure to form an opening of the circuit structure to expose the optical active surface of the photonic element; disposing an optical element at the opening of the circuit structure to be combined with or corresponding to the optical active surface of the photonic element; and forming an encapsulation layer on the first side of the circuit structure and the optical element to cover the optical element.

In the aforementioned co-optical package and method, the circuit structure further has a first circuit layer, a second circuit layer and an insulating layer, the first circuit layer and the second circuit layer are respectively located on the first side and the second side of the circuit structure, the insulating layer is between the first circuit layer and the second circuit layer, and the photonic element is embedded in the insulating layer.

In the aforementioned co-optical package and method, the opening of the circuit structure is a tapered opening, a dimension of a first end of the opening is greater than a dimension of a second end of the opening, and the second end of the opening corresponds to the optical active surface of the photonic element.

In the aforementioned co-optical package and method, a dimension of an end of the opening of the circuit structure is greater than a dimension of the optical active surface of the photonic element, and the end of the opening of the circuit structure corresponds to the optical active surface of the photonic element.

In the aforementioned co-optical package and method, the at least one electronic element comprises a first electronic element, a second electronic element and a third electronic element, the first electronic element is embedded in the circuit structure, and the second electronic element and the third electronic element are disposed on the first side of the circuit structure.

In the aforementioned co-optical package and method, the encapsulation layer is formed on the first side of the circuit structure, the second electronic element, the third electronic element and the optical element and covers the second electronic element, the third electronic element and the optical element.

In the aforementioned co-optical package and method, the first electronic element is a bridge element or a bridge chip, the second electronic element is a system on a chip, the third electronic element is an electrical integrated circuit, and the photonic element is a photonic chip, a photonic integrated circuit, or a silicon photonic element.

In the aforementioned co-optical package and method, the optical element has an active part directly in contact with the optical active surface of the photonic element, thereby the active part of the optical element is directly combined with the optical active surface of the photonic element.

In the aforementioned co-optical package and method, the optical element has an active part, and a height of the active part of the optical element is greater than a depth of the opening of the circuit structure.

In the aforementioned co-optical package and method, the optical element has a slope, and the slope corresponds to the optical active surface of the photonic element and the optical fiber at the same time, thereby an optical signal provided by the optical fiber is transmitted to the optical active surface of the photonic element through the slope of the optical element.

As can be seen from the above, in the co-optical package and manufacturing method thereof of the present disclosure, at least one electronic element (such as a first electronic element, a second electronic element, and/or a third electronic element), a photonic element (such as a photonic chip) and an optical element are effectively integrated via a single electronic module (such as a package module like a fan-out embedded bridge module) or a circuit structure.

Furthermore, the present disclosure can embed a photonic element (such as a photonic chip) in the circuit structure, and combine the photonic element with the optical element in special design to facilitate the reduction/elimination of the alignment deviation between the optical element (the active part) and the optical active surface of the photonic element causing the loss of the optical signal.

Alternatively, the opening of the circuit structure of the present disclosure may be a tapered opening, so that the active part of the optical element can be effectively or rapidly aligned to the optical active surface of the photonic element through the tapered opening of the circuit structure.

Moreover, the optical element of the present disclosure may have a slope to concurrently correspond to the optical active surface of the photonic element (such as a photonic chip) and the optical fiber, thereby the optical signal provided by the optical fiber can be effectively transmitted to the optical active surface of the photonic element through the slope of the optical element.

Furthermore, the present disclosure may protect the second electronic element, the third electronic element, and/or the optical element from being damaged via an encapsulation layer, also may use the encapsulation layer to prevent the optical element from being damaged and affecting the coupling efficiency between the optical element and the photonic element (such as a photonic chip).

### BRIEF DESCRIPTION OF THE DRAWINGS

FIG. 1A to FIG. 1F are schematic cross-sectional views showing a manufacturing method according to an embodiment of a co-optical package of the present disclosure.

FIG. 2A to FIG. 2B are schematic cross-sectional views showing a circuit structure having a tapered opening in another embodiment of a co-optical package of the present disclosure.

FIG. 3 is a schematic cross-sectional view showing an active part of an optical element with a greater height in another embodiment of a co-optical package of the present disclosure.

### DETAILED DESCRIPTION

Implementations of the present disclosure are described below by embodiments. Other advantages and technical effects of the present disclosure can be readily understood by one of ordinary skill in the art upon reading the disclosure of this specification.

It should be noted that the structures, ratios, sizes shown in the drawings appended to this specification are provided in conjunction with the disclosure of this specification in order to facilitate understanding by those skilled in the art. They are not meant, in any ways, to limit the implementations of the present disclosure, and therefore have no substantial technical meaning. Without influencing the effects created and objectives achieved by the present disclosure, any modifications, changes or adjustments to the structures, ratios, or sizes are construed as falling within the scope covered by the technical contents disclosed herein. Meanwhile, terms such as “on,” “under,” “a,” “one,” “two,” “first,” “second,” “third,” and the like are for illustrative purposes, and are not meant to limit the scope implementable by the present disclosure. Any changes or adjustments made to the relative relationships, without substantially modifying the technical contents, are also to be construed as within the scope implementable by the present disclosure.

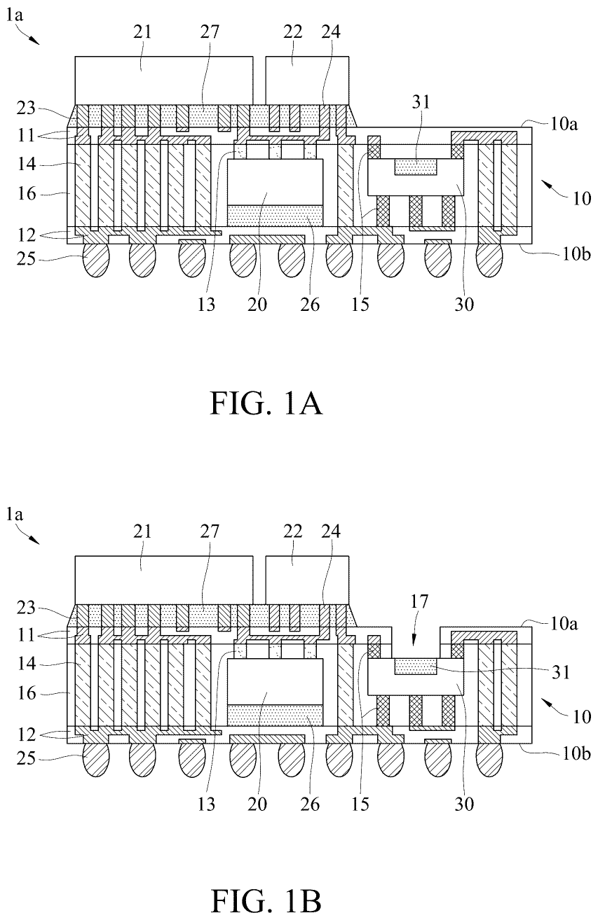

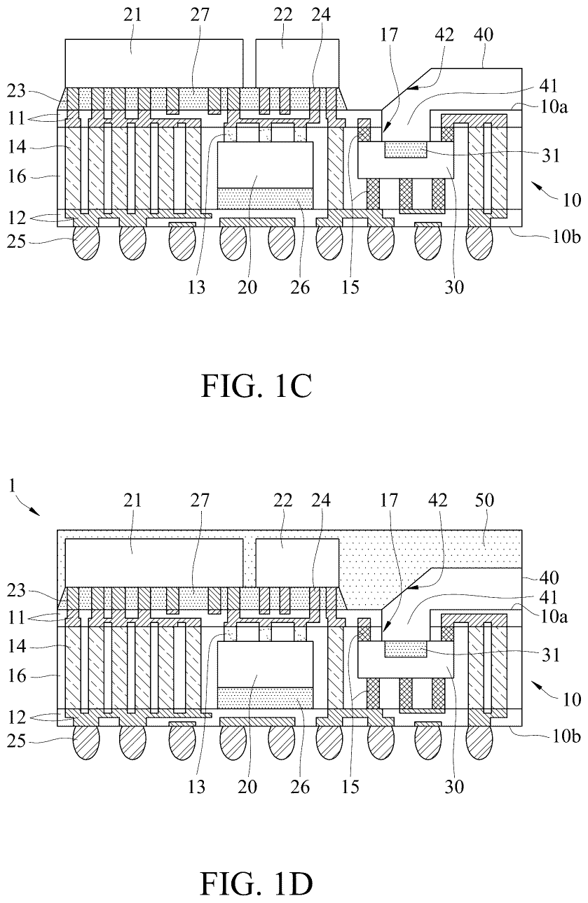

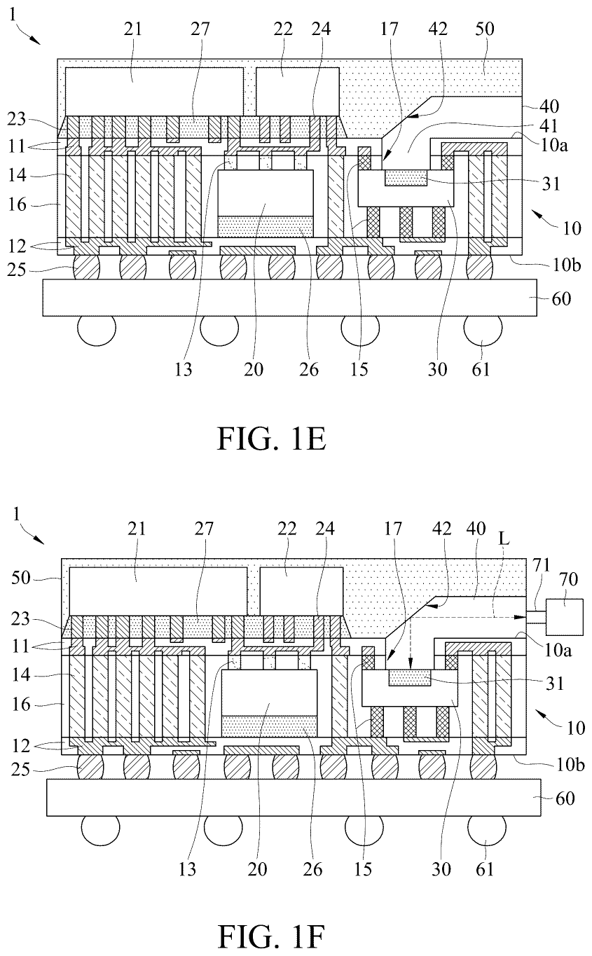

FIG. 1A to FIG. 1F are schematic cross-sectional views showing a manufacturing method of a co-optical package 1 of the present disclosure, and the co-optical package 1 can also be called a co-optical package structure or a co-packaged optics (CPO) structure, etc. At the same time, “at least one” mentioned in the present disclosure represents one or more (such as one, two, or three), and “a plurality of” mentioned in the present disclosure represents two or more (such as two, three, four, ten, or more).

As shown in FIG. 1A, a single electronic module 1a including a circuit structure 10, at least one electronic element (such as a first electronic element 20, a second electronic element 21, and/or a third electronic element 22) and a photonic element 30 (such as a photonic chip) is provided, such as a package module like a fan-out embedded bridge (FOEB) module.

In an embodiment, the circuit structure 10 defines a first side 10a and a second side 10b opposite to the first side 10a, and the circuit structure 10 has a first circuit layer 11, a second circuit layer 12, an insulating layer 16, etc.

In an embodiment, the first side 10a and the second side 10b can be the upper side and lower side of the circuit structure 10, respectively, and the first circuit layer 11 and the second circuit layer 12 can be formed on the first side 10a and the second side 10b of the circuit structure 10, respectively.

In an embodiment, the insulating layer 16 can be interposed between the first circuit layer 11 and the second circuit layer 12, and the first circuit layer 11 and the second circuit layer 12 are formed on the upper surface and the lower surface of the insulating layer 16, respectively, so the first electronic element 20 (such as a bridge chip), the photonic element 30 (such as a photonic chip), etc. are covered by the insulating layer 16.

Besides, the at least one electronic element may include the first electronic element 20, the second electronic element 21, and/or the third electronic element 22, etc., and the at least one electronic element can be embedded in the circuit structure 10 or disposed on the first side 10a of the circuit structure 10.

In an embodiment, the first electronic element 20 (such as a bridge chip) can be embedded in the insulating layer 16 of the circuit structure 10 and bonded to or fixed to the second circuit layer 12 via a bonding layer 26, and the first electronic element 20 (such as a bridge chip) can be electrically connected to the second electronic element 21 (such as a system on a chip), the third electronic element 22 (such as an electrical integrated circuit), the photonic element 30 (such as a photonic chip), etc. respectively via a plurality of first conductive elements 13 and the first circuit layer 11.

Furthermore, a plurality of second conductive elements 14 can be embedded in the insulating layer 16 to be electrically connected to the first circuit layer 11 and the second circuit layer 12.

In an embodiment, the second electronic element 21 (such as a system on a chip) can be disposed on the first side 10a of the circuit structure 10, so that the second electronic element 21 (such as a system on a chip) is sequentially electrically connected to the first electronic element 20 (such as a bridge chip), the third electronic element 22 (such as an electrical integrated circuit), the photonic element 30 (such as a photonic chip), etc. via a plurality of first conductors 23 and the first circuit layer 11.

In an embodiment, the third electronic element 22 (such as an electrical integrated circuit) also can be disposed on the first side 10a of the circuit structure 10, so that the third electronic element 22 (such as an electrical integrated circuit) is sequentially electrically connected to the first electronic element 20 (such as a bridge chip), the second electronic element 21 (such as a system on a chip), the photonic element 30 (such as a photonic chip), etc. via a plurality of second conductors 24 and the first circuit layer 11.

In an embodiment, an underfill 27 can be formed between the second electronic element 21 (such as a system on a chip) and the first side 10a (the first circuit layer 11) of the circuit structure 10, and the underfill 27 also can be formed between the third electronic element 22 (such as an electrical integrated circuit) and the first side 10a (the first circuit layer 11) of the circuit structure 10, so that the plurality of first conductors 23 and the plurality of second conductors 24 are covered and protected by the underfill 27. A plurality of third conductors 25 can be formed on the second side 10b of the circuit structure 10 or on the second circuit layer 12.

Additionally, the photonic element 30 (such as a photonic chip) can be embedded in the insulating layer 16 of the circuit structure 10 and electrically connected to the first circuit layer 11 and the second circuit layer 12 via a plurality of third conductive elements 15, and further electrically connected to the at least one electronic element (such as the first electronic element 20, the second electronic element 21, and/or the third electronic element 22). The photonic element 30 (such as a photonic chip) can have an optical active surface 31, and the optical active surface 31 of the photonic element 30 can face to the first side 10a of the circuit structure 10 or the first circuit layer 11.

In an embodiment, the first circuit layer 11 or the second circuit layer 12 may be a redistribution layer (RDL), etc. The first conductive element 13, the third conductive element 15, the first conductor 23, the second conductor 24, or the third conductor 25 may be a conductive bump, a conductive contact, a solder ball, a tin ball, etc. The second conductive element 14 may be a conductive pillar, etc. The insulating layer 16 may be a dielectric layer, an encapsulation layer, etc. The bonding layer 26 may be a bonding colloid, an adhesive layer, etc. The underfill 27 may be an underfill material, an encapsulation layer, etc.

In an embodiment, the first electronic element 20 may be a bridge element or bridge chip, etc. The second electronic element 21 may be a system on a chip (SoC), etc. The third electronic element 22 may be an electrical integrated circuit (EIC). The photonic element 30 may be a photonic chip (such as a silicon photonic chip), a photonic integrated circuit (PIC), a silicon photonic element, etc.

As shown in FIG. 1B, using various removal techniques such as etching or drilling, and focus on the position of the optical active surface 31 of the photonic element 30 (such as a photonic chip) to remove a portion of the circuit structure 10 from the first side 10a of the circuit structure 10 to form an opening 17 of the circuit structure 10 to expose the optical active surface 31 of the photonic element 30.

As shown in FIG. 1C, an optical element 40 (such as a lens structure) is disposed at the opening of the circuit structure 10, so that the optical element 40 is combined with or corresponds to the optical active surface 31 of the photonic element 30 (such as a photonic chip).

In an embodiment, the optical element 40 (such as a lens structure) may have an active part 41 that is directly in contact with the optical active surface 31 of the photonic element 30 (such as a photonic chip), so that the active part 41 of the optical element 40 is directly combined with the optical active surface 31 of the photonic element 30.

In an embodiment, the optical element 40 (such as a lens structure) may have a slope 42 (oblique angle), and the slope 42 (oblique angle) of the optical element 40 may concurrently/respectively correspond to the optical active surface 31 of the photonic element 30 (such as a photonic chip) and an external optical fiber 71 (a laser 70), thereby an optical signal L provided by the external laser 70 or optical fiber 71 can be effectively transmitted to the optical active surface 31 of the photonic element 30 through the slope 42 (oblique angle) of the optical element 40 (see FIG. 1F).

As shown in FIG. 1D, an encapsulation layer 50 is formed on the first side 10a (the first circuit layer 11) of the circuit structure 10, the second electronic element 21 (such as a system on a chip), the third electronic element 22 (such as an electrical integrated circuit) and the optical element 40 (such as a lens structure) to cover and protect the second electronic element 21, the third electronic element 22, the optical element 40, etc., and one side (such as right side) of the optical element 40 is exposed from the encapsulation layer 50 for connecting or bonding the optical fiber 71. So far, the co-optical package 1 of the present disclosure can be obtained.

As shown in FIG. 1E, a substrate 60 can be further connected on the plurality of third conductors 25 on the second side 10b of the circuit structure 10, and a plurality of solder balls 61 are formed on the substrate 60.

As shown in FIG. 1F, the optical signal L is provided from, for example, the external laser 70 and/or optical fiber 71 into the optical element 40 (such as a lens structure), thereby the optical signal L provided from the laser 70 and/or the optical fiber 71 can be effectively transmitted to the optical active surface 31 of the photonic element 30 (such as a photonic chip) through the slope 42 (oblique angle) of the optical element 40 and the active part 41 of the optical element 40 in sequence.

In an embodiment, the optical element 40 may be a lens structure (such as an optical lens), etc. The encapsulation layer 50 may be an insulating protective layer, an encapsulation layer, an encapsulation colloid, etc. The substrate 60 may be a circuit board, a carrier board, a carrier, or a carrier substrate with at least one (such as a plurality of) circuit layer. The laser 70 may be a laser generator or a laser transmitter, etc.

Therefore, the present disclosure can embed the photonic element 30 (such as a photonic chip) in the circuit structure 10 of the single electronic module 1a (such as a package module like a fan-out embedded bridge module), and combine the photonic element 30 with the optical element 40 (such as a lens structure) in special design to facilitate the reduction/elimination of the alignment deviation between the optical element 40 (the active part 41) and the optical active surface 31 of the photonic element 30 causing the loss of the optical signal L. Also, the optical signal L provided by, for example, the laser 70 and/or the optical fiber 71 can be effectively entered (introduced) into the photonic element 30 through the optical element 40.

The present disclosure can effectively integrate at least one electronic element (such as the first electronic element 20, the second electronic element 21, and/or the third electronic element 22), the photonic element 30 (such as a photonic chip) and the optical element 40 (such as a lens structure) via the single electronic module 1a (such as a package module like a fan-out embedded bridge module) or the circuit structure 10, in order to achieve the purpose of the rapid transmission of the optical signal L provided by, for example, the laser 70 and/or the optical fiber 71.

The optical element 40 (such as a lens structure) of the present disclosure can have the slope 42 (oblique angle) in special design, so that the optical signal L provided by, for example, the laser 70 and/or the optical fiber 71 is effectively transmitted to the optical active surface 31 of the photonic element 30 (such as a photonic chip) through the slope 42 (oblique angle) of the optical element 40, and the slope 42 of the optical element 40 facilitates the reduction of the transmission loss of the optical signal L.

The present disclosure can effectively combine the photonic element 30 (such as a photonic chip) to the optical element 40 (such as a lens structure) in special design, also can protect the second electronic element 21, the third electronic element 22, and/or the optical element 40 from being damaged via the encapsulation layer 50, and also can use the encapsulation layer 50 to prevent the optical element 40 from being damaged to further affect the coupling efficiency between the optical element 40 and the photonic element 30 (such as a photonic chip).

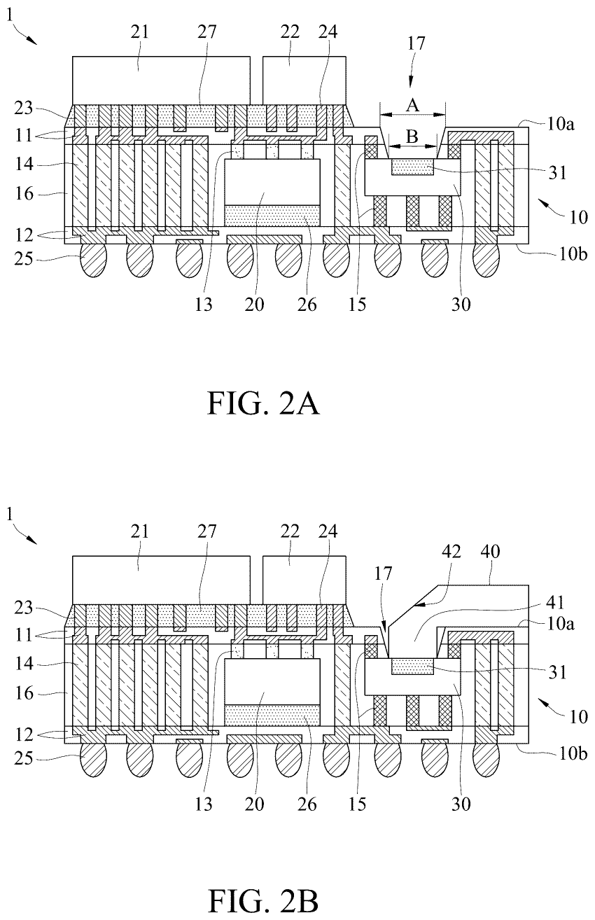

FIG. 2A to FIG. 2B are schematic cross-sectional views showing a circuit structure 10 having a tapered opening 17 in another embodiment of a co-optical package 1 of the present disclosure.

In an embodiment, the opening 17 of the circuit structure 10 may be a tapered opening (such as an opening from large to small), the dimension A of a first end (such as a top end) of the opening 17 is greater than the dimension B of a second end (such as a bottom end) of the opening 17, and the second end (such as a bottom end) of the opening 17 corresponds to the optical active surface 31 of the photonic element 30 (such as a photonic chip), so that the active part 41 of the optical element 40 (such as a lens structure) can be effectively or rapidly aligned to the optical active surface 31 of the photonic element 30 (such as a photonic chip) through the opening 17 (such as a tapered opening) of the circuit structure 10.

In an embodiment, the dimension B of an end (such as a second end) of the opening 17 of the circuit structure 10 is greater than the dimension of the optical active surface 31 of the photonic element 30 (such as a photonic chip), and an end (such as a second end) of the opening 17 corresponds to the optical active surface 31 of the photonic element 30 (such as a photonic chip), so that the active part 41 of the optical element 40 (such as a lens structure) can be effectively aligned to the optical active surface 31 of the photonic element 30 (such as a photonic chip) through the opening 17 of the circuit structure 10.

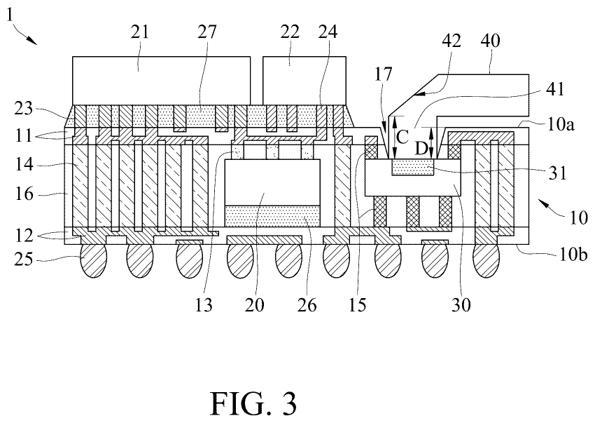

FIG. 3 is a schematic cross-sectional view showing an active part 41 of an optical element 40 with a greater height C in another embodiment of a co-optical package 1 of the present disclosure.

In an embodiment, the optical element 40 may have the active part 41, and the height C of the active part 41 of the optical element 40 may be greater than the depth D of an opening 17 of the circuit structure 10 to avoid causing interference when bonding or combining the active part 41 of the optical element 40 to the optical active surface 31 of the photonic element 30.

The present disclosure also provides a co-optical package 1, which comprises: a circuit structure 10 having a first side 10a, a second side 10b opposite to the first side 10a, and an opening 17, wherein the opening 17 is formed on the first side 10a of the circuit structure 10; at least one electronic element embedded in the circuit structure 10 or disposed on the first side 10a of the circuit structure 10; a photonic element 30 embedded in the circuit structure 10 and electrically connected to the at least one electronic element (such as a first electronic element 20, a second electronic element 21, and/or a third electronic element 22), wherein the photonic element 30 has an optical active surface 31 exposed from the opening 17 of the circuit structure 10; an optical element 40 disposed at the opening 17 of the circuit structure 10, wherein the optical element 40 is combined with or corresponds to the optical active surface 31 of the photonic element 30; and an encapsulation layer 50 formed on the first side 10a of the circuit structure 10 and the optical element 40 and covering the optical element 40.

In an embodiment, the circuit structure 10 further has a first circuit layer 11, a second circuit layer 12 and an insulating layer 16, the first circuit layer 11 and the second circuit layer 12 are respectively formed on the first side 10a and the second side 10b of the circuit structure 10, the insulating layer 16 is between the first circuit layer 11 and the second circuit layer 12, and the photonic element 30 is embedded in the insulating layer 16.

In an embodiment, the opening 17 of the circuit structure 10 is a tapered opening, the dimension A of a first end of the opening 17 is greater than the dimension B of a second end of the opening 17, and the second end of the opening 17 corresponds to the optical active surface 31 of the photonic element 30.

In an embodiment, the dimension B of an end (such as a second end) of the opening 17 of the circuit structure 10 is greater than the dimension of the optical active surface 31 of the photonic element 30, and the end (such as a second end) of the opening 17 of the circuit structure 10 corresponds to the optical active surface 31 of the photonic element 30.

In an embodiment, the at least one electronic element comprises the first electronic element 20, the second electronic element 21 and the third electronic element 22, the first electronic element 20 is embedded in the circuit structure 10, and the second electronic element 21 and the third electronic element 22 are both disposed on the first side 10a of the circuit structure 10.

In an embodiment, the encapsulation layer 50 is formed on the first side 10a of the circuit structure 10, the second electronic element 21, the third electronic element 22 and the optical element 40 and covers the second electronic element 21, the third electronic element 22 and the optical element 40.

In an embodiment, the first electronic element 20 is a bridge element or a bridge chip, etc., the second electronic element 21 is a system on a chip (SoC), etc., the third electronic element 22 is an electrical integrated circuit (EIC), etc., and the photonic element 30 is a photonic chip, a photonic integrated circuit (PIC), or a silicon photonic element, etc.

In an embodiment, the optical element 40 has an active part 41 that is directly in contact with the optical active surface 31 of the photonic element 30, thereby the active part 41 of the optical element 40 is directly combined with the optical active surface 31 of the photonic element 30.

In an embodiment, the optical element 40 has an active part 41, and the height C of the active part 41 of the optical element 40 is greater than the depth D of the opening 17 of the circuit structure 10.

In an embodiment, the optical element 40 has a slope 42 (e.g., an inclined surface) that concurrently/respectively corresponds to the optical active surface 31 of the photonic element 30 and the optical fiber 71, thereby the optical signal L provided by the optical fiber 71 is transmitted to the optical active surface 31 of the photonic element 30 through the slope 42 of the optical element 40.

To sum up, the co-optical package 1 and manufacturing method thereof of the present disclosure have at least the following features, advantages, or technical effects.
1. The present disclosure can effectively integrate at least one electronic element (such as the first electronic element 20, the second electronic element 21, and/or the third electronic element 22), the photonic element 30 (such as a photonic chip) and the optical element 40 (such as a lens structure) via the single electronic module 1a (such as a package module like a fan-out embedded bridge module), in order to achieve the purpose of the rapid transmission of the optical signal L provided by, for example, the laser 70 and/or the optical fiber 71.
2. The present disclosure can embed the photonic element 30 (such as a photonic chip) in the circuit structure 10, and combine the photonic element 30 with the optical element 40 (such as a lens structure) in special design to facilitate the reduction/elimination of the alignment deviation between the optical element 40 (the active part 41) and the optical active surface 31 of the photonic element 30 causing the loss of the optical signal L, also the optical signal L provided by, for example, the laser 70 and/or the optical fiber 71 can be effectively entered (introduced) into the photonic element 30 through the optical element 40.
3. The opening 17 of the circuit structure 10 of the present disclosure may be a tapered opening, the dimension A of the first end of the opening 17 is greater than the dimension B of the second end of the opening 17, and the second end of the opening 17 corresponds to the optical active surface 31 of the photonic element 30 (such as a photonic chip), so that the active part 41 of the optical element 40 (such as a lens structure) can be effectively or rapidly aligned to the optical active surface 31 of the photonic element 30 through the opening 17 (such as a tapered opening) of the circuit structure 10.
4. The dimension B of the second end (such as a bottom end) of the opening 17 of the circuit structure 10 of the present disclosure is greater than the dimension of the optical active surface 31 of the photonic element 30 (such as a photonic chip), so that the active part 41 of the optical element 40 (such as a lens structure) can be effectively aligned to the optical active surface 31 of the photonic element 30 through the opening 17 of the circuit structure 10.
5. The optical element 40 (such as a lens structure) of the present disclosure may have the slope 42 (oblique angle) to concurrently/respectively correspond to the optical active surface 31 of the photonic element 30 (such as a photonic chip) and the external optical fiber 71 (such as the laser 70), so that the optical signal L provided by, for example, the laser 70 and/or the optical fiber 71 can be effectively transmitted to the optical active surface 31 of the photonic element 30 through the slope 42 (oblique angle) of the optical element 40.
6. The optical element 40 (such as a lens structure) of the present disclosure may have the slope 42 (oblique angle) in special design, so that the optical signal L provided by, for example, the laser 70 and/or the optical fiber 71 is effectively transmitted to the optical active surface 31 of the photonic element 30 (such as a photonic chip) through the slope 42 (oblique angle) of the optical element 40, and the slope 42 of the optical element 40 also facilitates the reduction of the transmission loss of the optical signal L.
7. The height C of the active part 41 of the optical element 40 of the present disclosure may be greater than the depth D of the opening 17 of the circuit structure 10 to avoid causing interference when the active part 41 of the optical element 40 is bonded to or combined with the optical active surface 31 of the photonic element 30.
8. The present disclosure may form the encapsulation layer 50 on the first side 10a (the first circuit layer 11) of the circuit structure 10, the second electronic element 21 (such as a system on a chip), the third electronic element 22 (such as an electrical integrated circuit) and the optical element 40 (such as a lens structure) to protect the second electronic element 21, the third electronic element 22 and the optical element 40.
9. The present disclosure may protect the second electronic element 21, the third electronic element 22, and/or the optical element 40 from being damaged via the encapsulation layer 50, also may use the encapsulation layer 50 to prevent the optical element 40 from being damaged and affecting the coupling efficiency between the optical element 40 and the photonic element 30 (such as a photonic chip).

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. A co-optical package, comprising:
a circuit structure having a first side, a second side opposite to the first side, and an opening, wherein the opening is formed on the first side of the circuit structure;
at least one electronic element embedded in the circuit structure or disposed on the first side of the circuit structure;
a photonic element embedded in the circuit structure and electrically connected to the at least one electronic element, wherein the photonic element has an optical active surface exposed from the opening of the circuit structure;
an optical element disposed at the opening of the circuit structure, wherein the optical element is combined with or corresponds to the optical active surface of the photonic element; and
an encapsulation layer formed on the first side of the circuit structure and the optical element and covering the optical element.

2. The co-optical package of claim 1, wherein the circuit structure further has a first circuit layer, a second circuit layer and an insulating layer, the first circuit layer and the second circuit layer are respectively located on the first side and the second side of the circuit structure, the insulating layer is positioned between the first circuit layer and the second circuit layer, and the photonic element is embedded in the insulating layer.

3. The co-optical package of claim 1, wherein the opening of the circuit structure is a tapered opening, a dimension of a first end of the opening is greater than a dimension of a second end of the opening, and the second end of the opening corresponds to the optical active surface of the photonic element.

4. The co-optical package of claim 1, wherein a dimension of an end of the opening of the circuit structure is greater than a dimension of the optical active surface of the photonic element, and the end of the opening of the circuit structure corresponds to the optical active surface of the photonic element.

5. The co-optical package of claim 1, wherein the at least one electronic element comprises a first electronic element, a second electronic element and a third electronic element, the first electronic element is embedded in the circuit structure, and the second electronic element and the third electronic element are disposed on the first side of the circuit structure.

6. The co-optical package of claim 5, wherein the encapsulation layer is formed on the first side of the circuit structure, the second electronic element, the third electronic element and the optical element and covers the second electronic element, the third electronic element and the optical element.

7. The co-optical package of claim 5, wherein the first electronic element is a bridge element or a bridge chip, the second electronic element is a system on a chip, the third electronic element is an electrical integrated circuit, and the photonic element is a photonic chip, a photonic integrated circuit, or a silicon photonic element.

8. The co-optical package of claim 1, wherein the optical element has an active part directly in contact with the optical active surface of the photonic element, thereby the active part of the optical element is directly combined with the optical active surface of the photonic element.

9. The co-optical package of claim 1, wherein the optical element has an active part, and a height of the active part of the optical element is greater than a depth of the opening of the circuit structure.

10. The co-optical package of claim 1, wherein the optical element has a slope, and the slope corresponds to the optical active surface of the photonic element and the optical fiber at the same time, thereby an optical signal provided by the optical fiber is transmitted to the optical active surface of the photonic element through the slope of the optical element.

11. A method of manufacturing a co-optical package, the method comprising:
providing an electronic module including a circuit structure, at least one electronic element and a photonic element, wherein the circuit structure has a first side and a second side opposite to the first side, and the at least one electronic element is embedded in the circuit structure or disposed on the first side of the circuit structure, wherein the photonic element has an optical active surface, is embedded in the circuit structure and is electrically connected to the at least one electronic element;
removing a portion of the circuit structure from the first side of the circuit structure to form an opening of the circuit structure to expose the optical active surface of the photonic element;
disposing an optical element at the opening of the circuit structure to be combined with or corresponding to the optical active surface of the photonic element; and
forming an encapsulation layer on the first side of the circuit structure and the optical element to cover the optical element.

12. The method of claim 11, wherein the circuit structure further has a first circuit layer, a second circuit layer and an insulating layer, the first circuit layer and the second circuit layer are respectively located on the first side and the second side of the circuit structure, the insulating layer is between the first circuit layer and the second circuit layer, and the photonic element is embedded in the insulating layer.

13. The method of claim 11, wherein the opening of the circuit structure is a tapered opening, a dimension of a first end of the opening is greater than a dimension of a second end of the opening, and the second end of the opening corresponds to the optical active surface of the photonic element.

14. The method of claim 11, wherein a dimension of an end of the opening of the circuit structure is greater than a dimension of the optical active surface of the photonic element, and the end of the opening of the circuit structure corresponds to the optical active surface of the photonic element.

15. The method of claim 11, wherein the at least one electronic element comprises a first electronic element, a second electronic element and a third electronic element, the first electronic element is embedded in the circuit structure, and the second electronic element and the third electronic element are disposed on the first side of the circuit structure.

16. The method of claim 15, wherein the encapsulation layer is formed on the first side of the circuit structure, the second electronic element, the third electronic element and the optical element and covers the second electronic element, the third electronic element and the optical element.

17. The method of claim 15, wherein the first electronic element is a bridge element or a bridge chip, the second electronic element is a system on a chip, the third electronic element is an electrical integrated circuit, and the photonic element is a photonic chip, a photonic integrated circuit, or a silicon photonic element.

18. The method of claim 11, wherein the optical element has an active part directly in contact with the optical active surface of the photonic element, thereby the active part of the optical element is directly combined with the optical active surface of the photonic element.

19. The method of claim 11, wherein the optical element has an active part, and a height of the active part of the optical element is greater than a depth of the opening of the circuit structure.

20. The method of claim 11, wherein the optical element has a slope, and the slope corresponds to the optical active surface of the photonic element and the optical fiber at the same time, thereby an optical signal provided by the optical fiber is transmitted to the optical active surface of the photonic element through the slope of the optical element.
